(19) United States
(12) Patent Application Publication
(10) Pub. No.: US 2016/0019578 A1
(43) Pub. Date: Jan. 21, 2016

(54) METHOD OF LOG SCANNING

(71) Applicant: Yahoo! Inc., Sunnyvale, CA (US)

(72) Inventor: Ram Sriharsha, Santa Clara, CA (US)

(21) Appl. No.: 14/334,494

(22) Filed: Jul. 17, 2014

(51) Int. Cl. G06Q 30/02; G06F 17/30

(52) U.S. Cl. CPC G06Q 30/0242; G06F 17/30477

(57) ABSTRACT

Example methods, apparatuses, and/or articles of manufacture are disclosed that may be implemented, in whole or in part, using one or more computing devices to provide analysis of the distribution of overlaps of logs of values.

### BACKGROUND

1. Field

The present disclosure relates to log scanning, such as for internet-related logs, for example.

2. Information

Signals and/or states (e.g., physical signals and/or physical states) may be stored in one or more logs. In any number of possible situations, there may be a desire to evaluate the one or more logs. One example includes the evaluation of logs in connection with advertising campaigns.

However, evaluation of one or more logs may have technical issues, such as hardware, software, and/or network bottlenecks and/or limitations, for example, as the size of the logs and/or the volume of signals contained therein increases. Thus, for instance, as distributed systems increase in size and exchange ever increasing amounts of signals, some distributed systems may expend significant amounts of resources to perform log processing.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a Venn diagram illustrating a representation of log scanning for an example embodiment.

FIG. 2 is a schematic diagram illustrating certain features of an implementation of an example system.

FIG. 3 is a schematic diagram illustrating an implementation of an example computing environment, such as for signal transmission and/or reception.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems, and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes, and/or equivalents may occur to those skilled in the art. It is, therefore, to be understood that appended claims are intended to cover any and all modifications and/or changes as fall within claimed subject matter.

Reference throughout this specification to “one implementation,” “an implementation,” “one embodiment,” “an embodiment” and/or the like may mean that a particular feature, structure, and/or characteristic described in connection with a particular implementation and/or embodiment may be included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described may be combined in various ways in one or more implementations. In general, of course, these and other issues may vary with context. Therefore, particular context of description and/or usage may provide helpful guidance regarding inferences to be drawn.

Operations and/or processing, such as in association with networks, such as communication networks, for example, may involve physical manipulations of physical quantities. Typically, although not necessarily, these quantities may take the form of signals and/or states, such as magnetic and/or electrical signals, for example, capable of, for example, being stored, transferred, combined, processed, compared, and/or otherwise manipulated. It has proven convenient, at times, principally for reasons of common usage, to refer to these signals as bits, data, values, elements, symbols, characters, terms, numbers, numerals, and/or the like. It should be understood, however, that all of these and/or similar terms are to be associated with appropriate physical quantities and are intended to merely be convenient labels.

In this context, the terms “coupled,” “connected,” and/or similar terms, may be used. It should be understood that these terms are not intended as synonyms. Rather, “connected” may be used to indicate that two or more elements and/or other components, for example, are in direct physical and/or electrical contact; while, “coupled” may mean that two or more components are in direct physical, including electrical contact; however, “coupled” may also mean that two or more components are not in direct contact, but may nonetheless co-operate and/or interact. The term “coupled” may also be understood to mean indirectly connected, for example, in an appropriate context.

The terms, “and,” “or,” “and/or,” and/or similar terms, as used herein, may include a variety of meanings that also are expected to depend at least in part upon the particular context in which such terms are used. Typically, “or” if used to associate a list, such as A, B, or C, is intended to mean A, B, and C, here used in the inclusive sense, as well as A, B, or C, here used in the exclusive sense. In addition, the term “one or more” and/or similar terms may be used to describe any feature, structure, and/or characteristic in the singular and/or may be used to describe a plurality or some other combination of features, structures and/or characteristics. In this context, the term “between” and/or similar terms are understood to include “among” if appropriate for the particular usage. Likewise, in this context, the terms “compatible with,” “comply with” and/or similar terms are understood to include substantial compliance and/or substantial compatibility. Though it should be noted that these are merely illustrative examples and claimed subject matter is not limited to this example.

The term “network device” may refer to any device capable of communicating via and/or as part of a network. Network devices may be capable of sending and/or receiving signals (e.g., signal packets), such as via a wired and/or wireless network, may be capable of performing arithmetic and/or logic operations, processing and/or storing signals, such as in memory as physical memory states, and/or may, for example, operate as a server. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof.

It should be understood that for ease of description, a network device may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

A network may comprise two or more network devices and/or may couple network devices so that signal communications, such as in the form of signal packets, for example, may be exchanged, such as between a server and a client device and/or other types of network devices, including between wireless devices coupled via a wireless network, for example. It is noted that the terms, server, server device, server computing device, server computing platform, and/or similar terms are used interchangeably. While in some instances, for ease of description, these terms may be used in the singular, such as by referring to a “client device,” “client computing device,” “server device,” or a “services platform,” the description is intended to encompass one or more client devices, and/or one or more server devices/platforms, as appropriate. Along similar lines, references to a “database” are understood to mean, one or more databases and/or portions thereof, as appropriate. It is noted that terms, such as “operation”, “function,” and/or the like may be used interchangeably in this context.

A network may also include now known, and/or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, and/or any combination thereof. Thus, a network may be worldwide in scope and/or extent. Likewise, sub-networks, such as may employ differing architectures, including being compliant and/or compatible with differing protocols, such as communication protocols (e.g., network communication protocols), may interoperate within a larger network. Various types of devices may be made available so that device interoperability is enabled and/or, in at least some instances, may be transparent to the devices. In this context, the term transparent refers to communicating in a manner so that communications may pass through intermediaries, but without the communications necessarily specifying one or more intermediaries, such as intermediate devices, and/or may include communicating as if intermediaries, such as intermediate devices, are not necessarily involved. For example, a router may provide a link between otherwise separate and/or independent LANs. In this context, a private network refers to a particular, limited set of network devices able to communicate with other network devices in the particular, limited set, such as via signal packet transmissions, for example, without a need for re-routing and/or redirecting such communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. As another example, a logical broadcast domain may comprise an example of a private network. It is understood in this context that a private network may provide outgoing communications to devices not in the private network, but such devices outside the private network may not direct inbound communications to devices included in the private network.

The Internet refers to a decentralized global network of interoperable networks, including devices that are part of those interoperable networks. The Internet includes local area networks (LANs), wide area networks (WANs), wireless networks, and/or long-haul public networks that, for example, may allow signal packets to be communicated between LANs. The term world wide web (WWW) and/or similar terms may also be used to refer to the Internet. Signal packets, also referred to as signal packet transmissions, may be communicated between nodes of a network, where a node may comprise one or more network devices, for example. As an illustrative example, but without limitation, a node may comprise one or more sites employing a local network address. Likewise, a device, such as a network device, may be associated with that node. A signal packet may, for example, be communicated via a communication channel and/or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address.

Physically connecting portions of a network via a hardware bridge, as one example, may be done, although other approaches also exist. A hardware bridge, however, may not typically include a capability of interoperability via higher levels of a network protocol. A network protocol refers to a set of signaling conventions for communications between and/or among devices in a network, typically network devices, but may include computing devices, as previously discussed; for example, devices that substantially comply with the protocol and/or that are substantially compatible with the protocol. Typically, a network protocol has several layers. These layers may be referred to here as a communication stack. Various types of communications may occur across various layers. For example, as one moves higher in a communication stack, additional functions may be available by transmitting communications that are compatible and/or compliant with a particular network protocol at these higher layers. A network may be very large, such as comprising thousands of nodes, millions of nodes, billions of nodes, or more, as examples.

Media networks, such as the Yahoo!™ network, for example, may be increasingly seeking ways to attract users to their networks and/or to retain users within their networks for extended periods of time. A media network may, for example, comprise an Internet website and/or group of websites having one or more sections. For instance, the Yahoo!™ network includes websites located within different categorized sections, such as sports, finance, current events, and games, to name just a few non-limiting examples among a variety of possible examples. To attract and/or retain users within its network, Yahoo!™ and/or other media networks may continually strive to provide content relating to categorized sections that may be interesting and/or of use to users.

As more users remain within a media network for extended periods of time, a media network may become more valuable to potential advertisers. Thus, typically, advertisers may be inclined to pay more money and/or provide other considerations to a media network in return for advertising to users, for example, via that media network, its partners, and/or subsidiaries. In an implementation, if a user displays a page, perhaps as a result of utilizing a search engine, a server, as an example, located within or external to a processing and/or communications infrastructure of a media network may deliver relevant content, which may include, for example, textual and/or multimedia content that may entice users to remain for a relatively extended period of time.

Hereinafter, signals and/or states will collectively be referred to as “signals,” with no loss of generality. Signals may be related to a given user and may comprise a user profile, such as, for example, user biographical content, user purchases, user click history, user search history, among other things. However, signals may not necessarily be related to users and/or a particular user. Signals may refer to any values relevant to a given distributed application, system, and/or network, among other things. Furthermore, in one embodiment, signals may be stored and/or represented in one or more logs, as previously suggested. As used herein, a log may comprise any suitable form and/or format capable of storing and/or representing signals, such as, for example, related to user behavior and/or related tendencies on the Internet. In one or more embodiments, a log may comprise and/or be stored in a database. In this context, an internet-related log refers to a log of internet-related interactions and/or transactions.

In some implementations of distributed systems, there may be large numbers of logs and/or stored signals for which evaluation may be desired. An illustrative example may comprise that of a social network for which there may be a desire to evaluate user behavior and/or tendencies, for example. Another example may comprise, for example, an electronic message provider for which there may be a desire to evaluate logs related to electronic messages. In yet another example, security agencies may wish to evaluate user behavior and/or Internet traffic, such as represented by signals in one or more logs. These are, of course, but a handful of possible scenarios where there may be a desire to evaluate signal content, such as may be exchanged in a distributed system.

In situations, for example, where potentially large volumes of signals are to be evaluated, such as, the foregoing illustrative examples, manipulation and/or evaluation of signals, states, and/or corresponding logs may present one or more technical challenges. For instance, as volume and/or number of signals stored in logs increases, there may also be an increase in computing, software, and/or hardware overhead and/or bottlenecks. As an example, consider a social network with an increasing number of users. While an amount of signals exchanged, created, and/or stored by users may initially be relatively low, signals traversing the social network on a daily basis may increase as the user base grows. Thus, signals exchanged and/or stored on a daily basis may ultimately become on the order of hundreds of terabytes, if not more. Of course, while evaluating volumes of signals may present challenges, the foregoing example is but one example of a challenge potentially addressed by subject matter described herein.

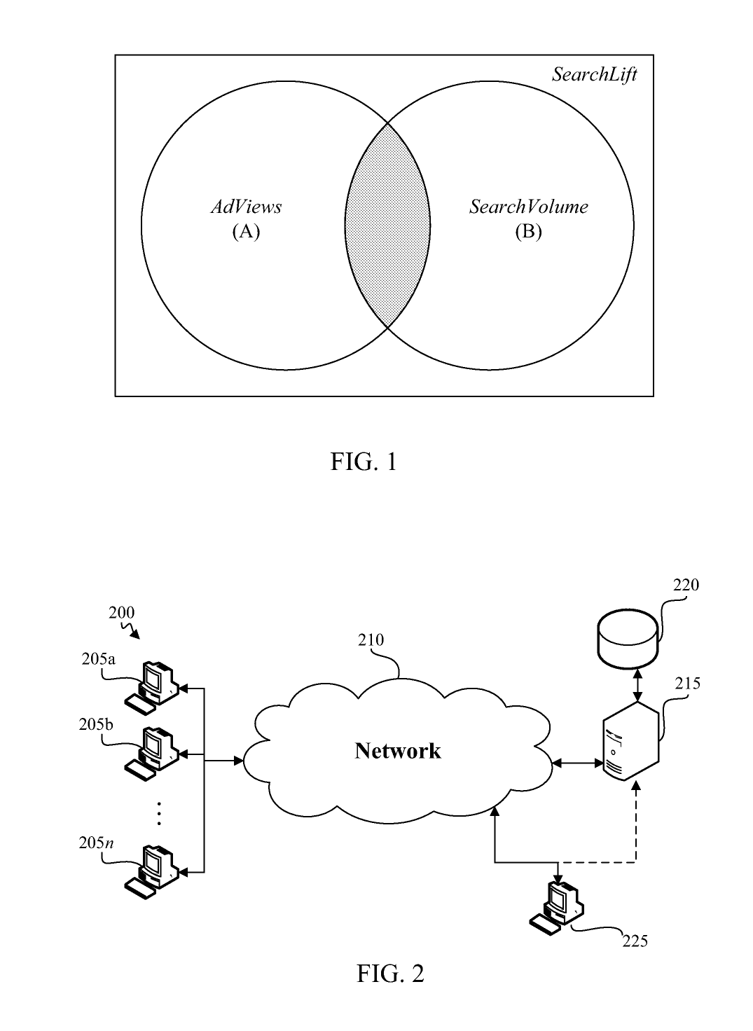

In one or more implementations, evaluation of signals may employ Venn diagrams and/or contingency tables, such as, for example, illustrated in FIG. 1. A contingency table refers to a format for reporting frequency distribution of associated signals, in this context, made accessible in memory, as illustrated in more detail below. It is therefore understood that in this context a contingency table need not be tabular graphically and, likewise, particular entries need not be physically co-located in memory so long as they are logically associated and accessible. It may be convenient to consider a Venn diagram and/or contingency table as representing an overlap among logs of signals. As an illustrative example, a log of signals representing user searches may be evaluated in conjunction with a log of signals representing user page views. Thus, it may be desirable to determine which users searched for term A and also viewed a webpage related to A. The resulting intersection of logs may be represented using a Venn diagram and/or a contingency table.

In one implementation, a conventional approach may perform multiple passes of available logs to count instances for particular events, such as viewing a page or performing a search (e.g., via SQL database operations). This is illustrated below by pseudo code example 1, in which multiple passes through logs are employed to compute an intersection, for example.

However, rather than performing multiple log scans, in an embodiment, it may be possible to scan available logs in a single pass to generate an accumulation of results according to a unifying schema. The terms ‘unifying schema’ in this context refers to using a common set of variables over multiple sets of logs to generate a single accumulation of results. Thus, in one embodiment, an accumulation of results may be generated from a single scan of a plurality of logs. In a single scan, a unifying schema may be used, for example, to map log results into an accumulation of results. Furthermore, portions of an accumulation of results, such as stored entries, may correspond to a contingency table and/or a Venn diagram for one or more embodiments, as explained in more detail below.

One illustrative example relates to an advertising campaign in connection with online searches. Likewise, the Venn diagram shown in FIG. 1 is meant to be applicable. For example, a type of marketing evaluation referred to as “Lift” may be employed in connection with searches. This approach is referred to here as SearchLift. In SearchLift, measuring effectiveness of an advertising campaign may be evaluated using search logs. For example, one may evaluate whether or not an increase in search volume associated with keywords related to an advertising campaign has occurred to measure effectiveness of an ad campaign. For example, an advertising campaign related to a keyword, A, may see a corresponding increase in search volume on keyword A. If so, an advertising campaign likely had a desired effect in that it likely affected user behavior; furthermore, a size of an effect may likewise be quantified; a greater volume of searches indicates greater effectiveness. That is, a greater volume of searches indicates that user behavior has been affected to a greater extent, which is typically desirable. As used herein, SearchLift refers to an evaluation of logs to quantify a ratio of the proportion of search queries relevant to an advertising campaign submitted by users who were exposed to the ad campaign on the one hand, and the proportion of search queries related to an advertising campaign submitted by users who were not exposed to the ad campaign on the other hand. This ratio of proportions may be described mathematically as the ratio of eff(T), where T represents the group of users exposed to the ad campaign and eff(T) represents a proportion of the search queries that were relevant to the advertising campaign, to eff(C), where C represents the group of users not exposed to the ad campaign. Thus, SearchLift may be described as:

$$SearchLift = \frac{eff ( T )}{eff ( C )} .$$

And if for this example we assume that relevance eff(x) is quantified and bounded between 0 and 1, it should be understood that SearchLift will yield a result greater than or equal to 1 as the estimated effectiveness of the advertising campaign increases. That is, if the advertising campaign is effective, it may be assumed that the group T will have a greater proportion of relevant search queries than will group C, which was not exposed to the campaign.

Logs, denoted by AdViews (or “A” for short) in FIG. 1, may be scanned to determine those users who viewed an ad campaign to be evaluated, as an illustrative example. Additionally, logs, denoted by SearchVolume (or “B” for short) in FIG. 1, may likewise be scanned to determine those users who searched on keywords related to an ad campaign. Thus, in this example, evaluating effectiveness of a campaign may comprise determining a number of users who viewed an ad campaign-in-question and searched on related keywords.

Thus, in this example, logs A and B may include entries for an overlapping set of users (e.g., an intersection of users). Thus, log A may include a first set of users, and log B may include a second set of users. An overlap or intersection of the sets of users, comprising users found in A and found in B, is represented by overlapping circles in the Venn diagram in FIG. 1.

Therefore, counting (e.g., measuring), for instance, A∩B, A∪B, among other potential measures, may be desirable. In one embodiment, this may be performed using SQL, though it is noted that claimed subject matter is not restricted in scope to SQL implementations. In SQL, queries may compute an inner join, and left and right outer joins, referring to FIG. 1. To illustrate this, pseudo code provided below, Pseudo Code Example 1, may correspond to a query for computing A∩B:

SELECT
COUNT(DISTINCT f.user)
FROM adviews f JOIN search g
ON
f.user = g.user
AND
f.adid = 1234
AND
g.search = ‘honda’;

### Pseudo Code Example 1

Thus, Pseudo Code Example 1, performs a JOIN computation with respect to an “adviews” log and a “search” log (e.g., A and B in FIG. 1) and looks for user entries with an ad ID (e.g., adid). As shown, a computation substantially in accordance with Pseudo Code Example 1 will yield a count (e.g., measure) of an intersection of logs A and B.

However, additional computation is desirable in this example. In one embodiment, an intersection of A and B alone may not provide a meaningful indication of effectiveness of a campaign. For example, for a SearchLift evaluation, it is desirable to compare a number of searches for ad related keywords to an overall number of searches (e.g., from the logs). An overall number of searches is shown in FIG. 1 as a right side circle, referred to as B in FIG. 1.

Since A∩B has been measured, to compute B, a computation of a right outer join (B/A) may be performed. Thus, in this example, an overall number of searches, B, comprises a sum of A∩B and (B/A). Therefore, to provide meaning to query results, an outer join (B/A) may be computed with SQL pseudo code similar to Pseudo Code Example 2, below.

SELECT
COUNT(DISTINCT f.user)
FROM adviews f RIGHT OUTER JOIN search g
ON
f.user = g.user
AND
f.adid =1234
AND
g.search = “honda”
AND
g.user is NULL;

### Pseudo Code Example 2

However, completing a computation, such as the example above, may involve performing joins over large volumes of logs. For instance, some search engines may see daily advertising events on the order of tens of billions of events, if not more. In cases involving large volumes, computing joins over relevant logs using a large-scale processing system (such as, Hadoop) may lead to multiple hours per day of log processing. To arrive at the Venn diagram illustrated in FIG. 1, three to four different joins, using the previously described approach, are computed. Thus, use of resources to perform join computations may be large.

In an embodiment, claimed subject matter permits logs scanned in a single pass to generate an accumulation of results, typically resulting in consumption of fewer resources to perform computations similar to those previously described, for example. As discussed previously, an accumulation of results may correspond to a contingency table and/or a Venn diagram. Using the example previously described, rather than querying logs separately (e.g., using joins, etc.), as discussed, a single scan of logs may generate a single accumulation of results according to a unifying schema. The terms ‘unifying schema’ in this context refers to using a common set of variables over multiple sets of logs to generate a single accumulation of results. Thus, in one example, a tuple such as [user, fact, count, dt, action] may be used to generate an accumulation of results. In one embodiment, a unifying schema may facilitate mapping values from multiple logs into a single accumulation of results. In one embodiment, use of an accumulation of results may enable performing computations without using join operations, for example, potentially reducing resources expended and/or reducing time to generate results. Furthermore, indexing, which often is employed in connection with database operations, may not necessarily be needed. For example, in an embodiment in which a scan of every entry is performed to generate an accumulation of results, indexing may be unnecessary and potentially less efficient. Therefore, in at least some situations, an accumulation of results may not need to be indexed.

As shown in FIG. 2, in one embodiment, a distributed system 200 may comprise a plurality of client devices 205a-205n that are coupled via network 210 to a remote server 215. Signals may be exchanged between client devices 205a-205n and remote server 215 via network 210. In one example, exchanged signals may be related to a distributed application, such as, for example, a social network, a search engine, and/or a news portal, among other things. In one embodiment, remote server 215 may transmit signals related to an advertisement. Transmitted signals may comprise an advertisement labeled ‘ad-1234.’ Thus, an ad may be displayed, for instance, via client device 205a and via client device 205n. Remote server 215 may store a record of ads displayed and a record of client devices that displayed the ads, such as in a log within database 220. Additionally, in one embodiment, client devices 205a-205n may transmit signals to remote server 215 related to an Internet search. For instance, an Internet search for a term “honda” may be performed via client devices 205a and 205b. A record of these searches may likewise be stored in a log within database 220.

In an embodiment, a device 225 may be coupled to server 215, either directly or via a network, such as 210, and may be capable of scanning logs, for example. Referring to the previous example, in one embodiment, logs A and B corresponding to AdViews and SearchVolume, for example, may be scanned using a unifying schema to generate an accumulation of results. Thus, an AdViews log may include the following entries, for example:

[user fact action]

[[“user-1” “ad-1234” “adview”]

[“user-3” “ad-1234” “adview”]]

and a SearchVolume log may include the following entries:

[user fact action]

[[“user-1” “honda” “search”]

[“user-2” “honda” “search”]].

Thus, as described, in an embodiment, logs may be scanned in a single pass using a unifying schema to generate an accumulation of results. As an example, an accumulation of results may yield:

{“user-1” {“honda-search” 1 “honda-adview” 1}

“user-2” {“honda-search” 1}

“user-3” {“honda-adview” 1} }

An accumulation of results may comprise a multiset in an embodiment. Thus, a count may be made corresponding to a number of times an action and/or an interaction occurred. In this example, user-1 had a search using keyword ‘honda,’ and an adview of an advertisement related to ‘honda’. User-2 had a search using keyword ‘honda,’ and user-3 had an adview of an advertisement related to the ‘honda.’

As previously suggested, a single pass rather than multiple passes of logs may be employed, which potentially may reduce resources expended in processing logs. For example, a query may generate a count of users for whom “honda-search” and “honda-adview” are non-empty, in this example, user-1.

Furthermore, in an embodiment, using an aggregate function with one or more nested sub-queries, described in more detail below, may lead to increases in performance and/or decreases in use of processing. As used herein, an aggregate function may refer to a function that aggregates multiple sets of associated values into a single set of associated values. In an embodiment, an aggregate function may be defined by a user (e.g., user-defined aggregate function). Thus, in one embodiment, an aggregate function may accept multiple sets of values as an input, and may output an accumulation of results and/or a count (e.g., one set of values).

For instance, employing the example previously discussed as an illustration, Pseudo Code Example 3 is provided below, as an illustration.

```
SELECT count(*) FROM
(SELECT user, segment(a,1) m FROM
(SELECT
user ,
  (CASE
  WHEN (action = ‘search’ and fact = ‘honda’ ) THEN ‘honda-search’
  WHEN (action = ‘adview’ and fact = ‘1234’ ) THEN ‘honda-adview’
  ELSE ‘other’
  END) a
FROM table
group by user) x
group by user) y
WHERE size (map_keys(m)) = 2;
```

### Pseudo Code Example 3

Thus, substantially in accordance with Pseudo Code Example 3, entries in AdView and SearchVolume logs are to be scanned in a single pass to identify and count users who searched for ‘honda’ and users who viewed ad 1234. Thus, in this embodiment, an inner sub-query generates all four sides, so to speak, of a Venn diagram, such as illustrated in FIG. 1, and passes those results to another function that performs an aggregation of results so that counts for use in an evaluation substantially in accordance with SearchLift may be made.

Additionally, in one embodiment, it may be possible to further streamline processing, such as within an environment that uses MapReduce. MapReduce is a computation model for performing parallel operations on a plurality of logs, by way of example. For instance, MapReduce may be able to use multiple computing platforms operating in parallel to evaluate/transform/compute/etc. a plurality of logs. MapReduce may include two primary functions (referred to as “transformations” for consistency): map (which receives input values from one or more logs, transforms input values according to a given function, and returns a new multiset representing results) and reduce (which aggregates elements of a multiset using a given function and returns a result to a driver program). A node (e.g., computing platform) of a computing environment may store output results of map and reduce transformations. As the size and number of signals of a plurality of logs increases, so does the size of output values being stored for a stage of a given computation.

In a Hadoop-type architecture, rather than storing output values of a given function, it may be desirable to use “lazy” transformations that do not perform underlying computations of a transformation until a result is specifically requested from a driver program. “Lazy” transformations may create a computation chain representing computational operations to be performed as part of a transformation. Thus, in contrast to a MapReduce process, such as the example explained above, it may be desirable to create a computation chain representing computational operations that nodes of a computing environment may undertake to perform a given transformation. For instance, in one embodiment, a driver program may query a system with a pair of operations, query A and query B, relative to one or more logs of a plurality of logs. Query A may be passed to the system, which may determine a computation chain (e.g., computational operations) corresponding to query A execute for the one or more logs, which may be stored or saved. Query B may be subsequently passed to the system, which may determine a computation chain corresponding to query B executed for the one or more logs, and may combine a computation chain corresponding to query B with that corresponding to query A. In one embodiment, computation chains of subsequent transformations may also be combined with an existing computation chain. Thereafter, a driver program may request a result to a given query, and computing environment may be able to use a determined computation chain to produce a result for a driver program. It is noted that this functionality may be similar to Spark RDD operations.

Thus, in one embodiment, a computation chain may be copied and stored. In one embodiment, a copy of a computation chain may conserve resources and/or time, to perform a given transformation. Furthermore, because computational operations may be stored, one embodiment may permit a form of backtracking, referring to a computation chain, to troubleshoot issues if it turns out that errors are present. For example, computational operations of one or more transformations may be consulted to, for example, locate errors and/or inconsistencies in transformations of a given one or more logs of a plurality of logs.

Though the foregoing discussion uses a SearchLift example, it is understood that claimed subject matter is not so limited. Rather, claimed subject matter is intended to encompass any number of contexts and/or scenarios. By way of non-limiting examples, possible applications include search, content selection and/or sharing, such as for a social network, related to article viewing, etc., and/or cyber-attacks by a third party.

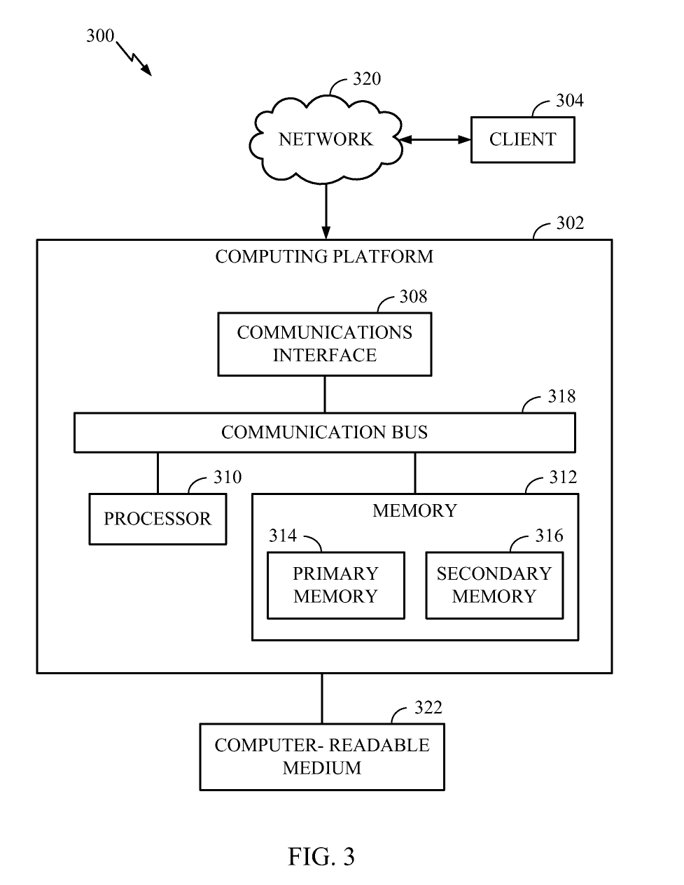

For purposes of illustration, FIG. 3 is a schematic diagram 300 of a computing platform that may be employed in a distributed system according to an embodiment. A computing platform, such as that embodied in FIG. 4 may comprise computing device 310 that may be employed to perform operations such as, for example, described herein. In FIG. 3, computing device 310 may represent a computing device capable of operating within a Hadoop and/or similar distributed computing framework. Computing device 310 may interface with client device 312, which may comprise features of a cellular telephone, a smart phone, a personal digital assistant, a wearable computer, a wrist phone, a laptop computer, a personal entertainment system, a tablet personal computer, a personal audio and/or video device, a personal navigation device, as well as other types of client devices, for example.

Communications interface 320, processor 350, and memory 370, which may comprise primary memory 374 and secondary memory 376, may communicate by way of communication bus 340, for example. In FIG. 3, computing device 310 may store various forms of computer-implementable instructions, by way of input/output module 430, for example, such as those that may be operative, for example, to provide metadata services, such as metadata path parameters for documents relevant to one or more search query terms. Client device 312 may communicate with computing device 310 by way of a wired and/or wireless Internet connection via network 315, for example. Although a computing platform, such as the computing platform embodied in FIG. 3 shows the above-identified components, claimed subject matter is not limited to computing platforms having only these components as other implementations may include alternative arrangements that may comprise additional components, fewer components, or components that function differently while achieving similar results. Rather, examples are provided merely as illustrations. It is not intended that claimed subject matter be limited in scope to illustrative examples.

Processor 350 may be representative of one or more circuits, such as digital circuits, to perform at least a portion of a computing procedure and/or process. By way of example but not limitation, processor 350 may comprise one or more processors, such as controllers, microprocessors, microcontrollers, application specific integrated circuits, digital signal processors, programmable logic devices, field programmable gate arrays, and the like, or any combination thereof. In implementations, processor 350 may perform signal processing to manipulate signals and/or states and/or to construct signals and/or states, for example.

Memory 370 may be representative of any storage mechanism. Memory 370 may comprise, for example, primary memory 374 and secondary memory 376, additional memory circuits, mechanisms, or combinations thereof may be used. Memory 370 may comprise, for example, random access memory, read only memory, or one or more data storage devices and/or systems, such as, for example, a disk drive, an optical disc drive, a tape drive, a solid-state memory drive, just to name a few examples. Memory 370 may be utilized to store a program, as an example. Memory 370 may also comprise a memory controller for accessing computer-readable medium 380. Under direction of processor 350, memory, such as cells storing physical states, representing, for example, a program, may be executed by processor 350 and generated signals may be transmitted via the Internet, for example. Processor 350 may also receive digitally encoded signals from computing device 310.

Network 315 may comprise one or more communication links, processes, and/or resources to support exchanging communication signals between a client computing device and server, which may, for example, comprise one or more servers (not shown). By way of example, but not limitation, network 315 may comprise wireless and/or wired communication links, telephone or telecommunications systems, Wi-Fi networks, Wi-MAX networks, the Internet, the web, a local area network (LAN), a wide area network (WAN), or any combination thereof

The term “computing platform,” as used herein, refers to a system and/or a device, such as a computing device, that includes a capability to process and/or store data in the form of signals and/or states. Thus, a computing platform, in this context, may comprise hardware, software, firmware, or any combination thereof (other than softwareer). Computing device 310, as depicted in FIG. 3, is merely one such example, and claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 370 may store cookies relating to one or more users and may also comprise a computer-readable medium that may carry and/or make accessible content, code and/or instructions, for example, executable by processor 350 or some other controller or processor capable of executing instructions, for example. A user may make use of an input device and/or an output device, such as a computer mouse, stylus, track ball, keyboard, and/or any other device capable of receiving an input from a user.

Regarding aspects related to a communications and/or computing network, a wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, and/or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or 2nd, 3rd, or 4th generation (2G, 3G, or 4G) cellular technology, and/or other technologies, or the like. Network access technologies may enable wide area coverage for devices, such as client devices with varying degrees of mobility, for example.

A network may enable radio frequency and/or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and a wireless network may be in accordance with known and/or to be developed cellular telephone communication network protocols including, for example, global system for mobile communications (GSM), enhanced data rate for GSM evolution (EDGE), and worldwide interoperability for microwave access (WiMAX). A computing device may also have a subscriber identity module (SIM) card, which, for example, may comprise a detachable smart card that stores subscription information of a user, and may also store a contact list of the user. A user may own the computing device and/or may otherwise be its primary user, for example. A computing device may be assigned an address by a wireless telephony network operator, a wired telephony network operator, and/or an Internet Service Provider (ISP). For example, an address may comprise a domestic and/or international telephone number, an Internet Protocol (IP) address, and/or one or more other identifiers. In other embodiments, a communication network may be embodied as a wired network, wireless network, or combination thereof.

A computing and/or network device may vary in terms of capabilities and/or features. Claimed subject matter is intended to cover a wide range of potential variations. For example, a network device may include a numeric keypad and/or other display of limited functionality, such as a monochrome liquid crystal display (LCD) for displaying text. In contrast, however, as another example, a web-enabled computing device may include a physical and/or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing device may include and/or may execute a variety of now known, and/or to be developed operating systems, or derivatives and/or versions, including personal computer operating systems, such as a Windows, iOS or Linux, or a mobile operating system, such as iOS, Android, or Windows Mobile, or the like. A computing device may include and/or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include and/or execute a software application to communicate content, such as, for example, textual content, multimedia content, or the like. A computing device may also include and/or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features and/or capabilities.

A network including a computing device, for example, may also be extended to another device communicating as part of another network, such as via a virtual private network (VPN). To support a VPN, transmissions may be forwarded to the VPN device. For example, a software tunnel may be created. Tunneled traffic may, or may not be encrypted, and a tunneling protocol may be substantially complaint with and/or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, and/or another existing protocol, and/or another protocol that may be developed.

A network may be compatible with now known, and/or to be developed, past, present, or future versions of any, but not limited to the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, or X.25. A network may employ, for example, TCP/IP, UDP, DECnet, NetBEUI, IPX, Appletalk, other, or the like. Versions of the Internet Protocol (IP) may include IPv4, IPv6, other, and/or the like.

It will, of course, be understood that, although particular embodiments will be described, claimed subject matter is not limited in scope to a particular embodiment and/or implementation. For example, one embodiment may be in hardware, such as implemented to operate on a device or combination of devices, for example, whereas another embodiment may be, at least in part, in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms, and/or symbolic representations of operations on binary signals and/or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these and/or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of processing, manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, as mentioned, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from one or more central concept(s) described herein. Therefore, it is intended that claimed subject matter not be limited to the particular examples disclosed, but that such claimed subject matter may also include all aspects falling within appended claims and/or equivalents thereof.

What is claimed is:

1. A method comprising:
scanning, via a processor of a computing device, a plurality of logs in a single pass to generate an accumulation of results, wherein the generating the accumulation of results further comprises mapping, via the processor, values of the plurality of logs in a manner so as to form the accumulation of results according to a unifying schema.

2. The method of claim 1, wherein the plurality of logs comprises a searches requested log corresponding to searches requested by a first set of one or more users, and an advertisements viewed log corresponding to advertisements viewed by a second set of one or more users, and wherein the accumulation of results comprises at least an intersection of the first set of one or more users and the second set of one or more users.

3. The method of claim 2 further comprising querying the accumulation of results generated to find instances of users within the intersection of the first and second sets of the one or more users having a non-empty value for a requested search from the searches requested log and a non-empty value for a corresponding advertisement view from the advertisements viewed log.

4. The method of claim 1, wherein the plurality of logs comprises internet-related logs.

5. The method of claim 1 further comprising querying the accumulation of results using one or more nested subqueries.

6. The method of claim 1, further comprising, after the scanning and generating, storing a computation chain corresponding to the scanning and generating.

7. The method of claim 6, wherein the storing the computation chain comprises storing a snapshot of the computation chain on a large scale network of devices.

8. The method of claim 1, wherein the accumulation of results is not indexed.

9. The method of claim 1, wherein the scanning and generating comprises using an aggregate function to compute search lift corresponding to online advertising campaigns.

10. The method of claim 9, wherein the aggregate function comprises a user-defined aggregate function.

11. An apparatus comprising:
at least one computing device to scan a plurality of logs in a single pass; the at least one computing device to further map values of the plurality of logs so as to generate an accumulation of results according to a unifying schema.

12. The apparatus of claim 11, wherein the accumulation of results is to comprise an intersection of values of the plurality of logs, and the at least one computing device is to query the accumulation of results for non-empty values in the intersection of values.

13. The apparatus of claim 12, wherein to query the accumulation of results is to comprise use of an aggregate function.

14. The apparatus of claim 12, wherein the plurality of logs is to comprise a searches requested log corresponding to searches requested by a first set of one or more users, and an advertisements viewed log to correspond to advertisements viewed by a second set of one or more users, and wherein the intersection of values is to comprise an intersection of the first set of one or more users and the second set of one or more users.

15. The apparatus of claim 12, wherein to query the accumulation of results is to comprise use of one or more nested subqueries.

16. The apparatus of claim 12, wherein to query the accumulation of results is to determine a SearchLift corresponding to an online advertising campaign.

17. An apparatus comprising:
means for scanning a plurality of logs in a single pass to generate an accumulation of results; and
means for mapping values of the plurality of logs in a manner so as to form the accumulation of results according to a unifying schema.

18. The apparatus of claim 17, wherein the plurality of logs is to comprise a searches requested log corresponding to searches requested by a first set of one or more users, and an advertisements viewed log corresponding to advertisements viewed by a second set of one or more users, and wherein the accumulation of results is to comprise at least an intersection of the first set of one or more users and the second set of one or more users.

19. The apparatus of claim 18 further comprising means for querying the accumulation of results generated to find instances of users within the intersection of the first and second sets of the one or more users having a non-empty value for a requested search from the searches requested log and a non-empty value for a corresponding advertisement view from the advertisements viewed log.

20. The apparatus of claim 17 further comprising means for querying the accumulation of results using one or more nested subqueries.
